(19) United States
(12) Patent Application Publication
(10) Pub. No.: US 2026/0020130 A1
(43) Pub. Date: Jan. 15, 2026

(54) SELF-POWERED TESTING AND ALERTING MODULE FOR A REMOTELY POWERED EGRESS LIGHT SOURCE

(71) Applicant: Exposure Illumination Architects, Inc., Scottsdale, AZ (US)

(72) Inventor: Daniel S. SPIRO, Scottsdale, AZ (US)

(73) Assignee: Exposure Illumination Architects, Inc., Scottsdale, AZ (US)

(21) Appl. No.: 19/076,411

(22) Filed: Mar. 11, 2025

Related U.S. Application Data
(63) Continuation-in-part of application No. 18/826,207, filed on Sep. 6, 2024, now Pat. No. 12,266,968.
(60) Provisional application No. 63/668,836, filed on Jul. 9, 2024.

(51) Int. Cl. H05B 47/20

(52) U.S. Cl. CPC H05B 47/20

(57) ABSTRACT

A decentralized system includes a dedicated self-powered testing module coupled to a processor/controller and a communication device that communicates to at least one remote client a failure condition of at least one power consuming device failure. The failure condition occurring under a condition where all normal house power and/or back-up power are unavailable.

### CROSS-REFERENCE TO RELATED APPLICATIONS

The present patent application is a continuation-in-part of, and claims priority to, U.S. patent application Ser. No. 18/826,207, filed Sep. 6, 2024, which claims the benefit of the earlier filing date of U.S. Provisional Application No. 63/668,836, filed Jul. 9, 2024, and contains subject matter related to that disclosed in U.S. patent application Ser. No. 18/653,762, filed May 2, 2024, as well as U.S. patent application Ser. No. 18/436,081 (now U.S. Pat. No. 12,085,274), filed Feb. 8, 2024, the entire contents of each of which being incorporated herein by reference.

### BACKGROUND

### Technical Field

The present disclosure relates to building egress lighting systems, apparatuses, methods, and computer program product, especially systems with disparate power sources.

### Discussion of Background

Egress lighting luminaires are configured to illuminate the path in a building leading to the building's exterior door/s. The luminaires are typically placed overhead and are spaced apart to form a continuous illuminated path on the floor. The path is referred to as the building's legal path of egress. The egress light source luminaire can be a stand-alone luminaire, coupled to an egress sign, or incorporated with an ambient lighting luminaire.

Modern egress light sources are commonly powered by either an integral power supply that receives line power or by a remote power source such as an inverter, a generator, geothermal power, a hydrogen engine, and/or other power source/s. As recognized by the present inventor, the integral power supply for emergency lighting is relatively short lived, costly, and requires continuous maintenance.

The integral power supply, typically a battery, is located inside the ambient luminaire (or standalone luminaire) that is ceiling mounted and thus requires special equipment and skilled labor for battery replacement. In addition, todays' egress light source commonly employs inefficient lensed optics and lamps placing greater power demands on the back-up power supply.

Advances in building technology have ushered in a new era where high powered energy efficient lamps and/or precision optical lenses control compact egress lighting sources. The new generation lamps' coupled optics can retire independent standalone luminaires and/or egress lighting luminaires incorporated with ambient lighting luminaires. At least one of such new generation egress light sources can be horizontally oriented, and can rotate about its vertical axis to co-align with a path of egress below (see Applicant's U.S. patent application Ser. No. 18/653,762, filed May 2, 2024).

Building and/or fire code mandates that the conductors for egress light sources are to be encased in a protective armored material. These egress light sources' conductors that are encased by the armored material can co-extend with at least ambient lighting conductors. The conductors' allowable voltage rating or, when used in modular wiring, the modular wiring system's allowable rating is defined by code. The code mandates that all conductors' ratings shall be no less than the highest allowable rated conductor and that the combined loads of the circuits does not exceed the rated allowable assembly voltage.

With rising labor and material costs today, placing egress lighting conductors in the same conduit of ambient lighting is desirable. The egress light conductor/s and the ambient lighting conductor/s are isolated from one another while cohabitating inside a single conduit, and are dedicated to the light sources that perform different illumination tasks. In the US, the egress light source is code mandated to maintain code compliant light levels over path of egress for at least 90 minutes.

When the egress light source is powered by remote power, a distance separates the light emitting element from its dedicated power source. As recognized by the present inventor, unless a testing and reporting/alerting module coupled to the egress light source continuously receives power from the remote power source, the testing and reporting/alerting module is of no value unless the resulting electrical structure adequately provides a solution that satisfies the following questions:
a. How does one know if there is a power disconnect between the remote power source and the luminaire retaining the egress light source?
b. How does one know if at least one of the egress light sources, the egress light driver, a processor, and a sensing device, a power generating device, a short-term power supply, and a communication device on board a luminaire fail?
c. How does one know if the ambient lighting luminaire operates?

The present application describes and shows various approaches that resolve the above challenges raised by these questions. The proposed solutions present a new paradigm to building electrical design focusing on remote power supply such as inverters to power egress lighting. With growing power density and devices reduced form, the Applicant expects significant demand growth for mini-inverters in the coming decade driven by a need for reduced material and labor costs.

In addition, today, low and high mounted building means of egress lighting and egress signage (BMEL) are commonly configured to be powered by local or remote backup power sources. A local power source can be a disposable battery and remote backup power source can be at least one of an inverter and a generator. However, as recognized by the present inventor, disposable batteries need to be replaced, and it is quite expensive and difficult to change the batteries in a large retail store where the lights are 30 feet or higher from the ground. Likewise, backup power in form of inverters and generators and not failsafe, and themselves suffer from reliability and maintenance issues.

Today's BMEL devices are not configured to host on-board dedicated power storage that is sufficient to communicate a device/system element fault to a remote client when power from a remote or local power source is unavailable. Further, today's BMEL monitoring technology is based on centralized architecture that relies on a remote client processor to detect and report faults within a network of BMEL devices. The BMEL's system architecture limitations include:
a. Inability to alert a remote attendant in real time on a BMEL's fault at a specific location
b. Inability to alert a remote attendant about the nature of the BMEL fault
c. Inability to discern power connectivity issues from failed electrical device
d. Reliance on physical inspection to monitor operational readiness
e. Inability to flexibly operate to suit the egress needs based on evolving environmental conditions in a building
f. Inability to interact with other building systems to save life and property

Present day BMEL fault detection technology relies on optical indicators that identify fault by visual inspection which requires human presence within line of sight of the indicator to detect the fault condition. In addition, BMEL, can jointly or separately include a sound emitting device to call attention to a faulty device. In building environments where a ceiling can reach as much as 50′-0″ above finished floor, identifying a light source indicator light showing fault is rather difficult. Furthermore, it is difficult to identify a faulty sound emitting BMEL that is mounted high, especially in an environment that is prone to echoing.

The key failure causes associated with contemporary BMEL art with integral (disposable) battery/ies can include:
a. Line power outage
b. Line power disconnection
c. Stepdown transformer failure
d. Charging board failure
e. Driver failure
f. Light source failure
g. Indicator sensory device failure, and
h. A processor and/or a communication device failure when included

The key failures associated with contemporary art egress/sign luminaire/s powered by a remote source can include:
a. Line power outage
b. Line power disconnection
c. Backup power outage
d. Backup power disconnection
e. Power generating device failure
f. Power temporary storage disconnection
g. Stepdown transformer failure
h. Charging board failure
i. Driver failure
j. Light source failure
k. Indicator sensory device failure
l. A processor/code failure
m. A local memory storage device failure
n. Communication device failure
o. A sensory/output device failure

### SUMMARY

The present innovation can detect and alert of at least four conditions that can prevent a building egress light powered by a remote back-up power supply from turning on when needed. These conditions include:

a. Power disconnects, such as that caused by a broken conductor, between a remote back-up power source and an egress light source.

b. At least one of an egress light source, an egress light driver, a microprocessor with code, a sensing device, a short-term power supply, and a communication device on board the luminaire with the coupled egress light source fail.

c. An ambient lighting luminaire that is supposed to energize an emergency light source short-term power supply on board fails.

d. At least two of the above conditions occur either simultaneously or independently of each other.

Detection and notifications described herein are available as an option in any of the disclosed embodiments. An indication of the detections and notifications can be displayed with a specific address of a device location as the device relates to a digital map. It also can provide and optionally display an alert (including an address) regarding failure of a specific subcomponent.

Furthermore, while US patent application U.S. Ser. No. 18/826,207 describes a self-powered egress/signage luminaire with processing and communication capabilities. The BMEL described herein can be configured to communicatively inform a remote client of a BMEL's failed device and/or a system element failure. The “last gasp” capability afforded by the BIT dedicated power storage enables a decentralized BMEL device to communicate to a remote client a myriad of fault types and forewarn a remote client of pending or eminent fault.

An exemplary architecture for a building illuminated means of egress employs a remote power back-up. Replacing disposable batteries from a ceiling mounted BMEL device significantly reduces the BMEL system maintenance and operating costs. For this reason, the preferred backup power source is a wall mounted inverter at arm's reach. The decentralized BMEL can be a member of a networked device that is communicatively coupled. The devices of the networked BMEL can include at least one other power consuming building system device. The decentralized communicative network can be configured to exchange information through point-to-point communication and/or through an intermediary processor controller. The system architecture of the present innovation expands on an egress lighting device capacity to generate and act on critical information sensed to protect life.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram of a power and monitoring system for an ambient light source, with built in test capabilities for monitoring continuously available power and functionality of an egress light source.

FIG. 2 is a diagram of another embodiment of a power and monitoring system according to the present disclosure.

FIG. 3 is a diagram of a further embodiment of a power and monitoring system according the present disclosure.

FIG. 4 is a block diagram of a processor/controller (computer processor) that provides control functionality for power control and device monitoring according to disclosed embodiments.

FIG. 5 is a diagram of a capacitor bank that includes a plurality of capacitors that provide a local power source for providing continuous monitoring, reporting and operating of built-in-test (BIT) circuitry even in the event of primary power disconnection, or other source of power outage, or device failure.

FIG. 6 is another block diagram of BIT circuitry according to the present disclosure and is included as part of self-power generated adaptive failure reporting (AFR) circuitry.

FIG. 7 is a flowchart of a BIT process to monitor for discontinuities in power, or electrical conductivity, in the power conductors that deliver power to the egress light source.

FIG. 8 is a flowchart of a BIT process for determining whether the egress lights are capable of providing sufficient optical energy when the egress lights are used, as well as a reporting capability of the status of the egress lights.

FIG. 9 is a circuit diagram of a boost circuit for boosting a DC level provided from a photovoltaic circuit to a higher DC voltage level, prior to storage in the capacitor bank.

FIG. 10 is a data structure of a regular status message reported by a BMEL.

FIG. 11 is a data structure of a last gasp message reported by a failing BMEL.

FIG. 12 is a proxy message reported by another BMEL on behalf of a failing or a failed BMEL

FIG. 13 is a flowchart of an algorithm performed by BMEL processing circuitry when preparing and transmitting a regular status message or a reduced capacity status message, such as a last gasp status message.

FIG. 14 is a flowchart of an algorithm performed by processing circuitry of a second BMEL which reports an operations status and perhaps a last gasp message, as a proxy, on behalf of a failed or failing BMEL, which is a different BMEL than the second BMEL

FIG. 15 is a diagram illustrating an example of training and using a machine learning model in connection of controlling BMELs and identifying a path of egress with a network of BMELs.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

Before turning to the detailed drawings, an overview of components used in exemplary systems described herein, as well as their functionality, is first described.

The present innovation is configured to prevent a building egress lighting failure due to the conditions described above by testing the system's operational conditions and alerting of failures. Notably different from systems where there is constant power between the remote power supply and the egress light source with a switching device in proximity to the egress light source, the conductors of the present egress lighting system can either be under constant load or not under constant load.

The present system introduces at least one of an operational self-testing module (built-in-test module) and an alerting module, which reports a detected failure. Self-testing and the alerting modules requires power to operate; however, the power and the duration needed to operate these modules is significantly less than the power required to operate the egress light source. The present innovation's power to operate the testing and alerting modules is harvested from an ambient lighting luminaire that at least one egress light source is coupled to or mounted in proximity to. Thus, the power is locally generated and locally maintained for use in built-in-test operations.

The present innovation enables an individual standalone egress light source luminaire and/or an egress light's light source coupled to an ambient lighting luminaire to independently power onboard self-testing and alerting module/s. The onboard testing and alerting module/s′ power can be generated by capturing radiant photonic energy generated by an onboard ambient lighting light source and/or light from other sources (e.g., an adjacent luminaire). The ambient light source can also be in the proximity of the egress light source. Other power generation methods can alternatively be used including induction and direct power storage from the ambient lighting power supply.

The proceeding example describes the use of photovoltaic cell/s to generate the modules' power.

The photovoltaic cell can couple to a surface of an ambient lighting luminaire and/or extend from a surface ambient lighting luminaire. The egress light source can couple to the same ambient lighting luminaire or can be in the vicinity of this ambient lighting luminaire. The photovoltaic cell's surface area directly or indirectly facing the luminaire's ambient lighting light source can be sized to generate sufficient power to operate at least one of a testing and a reporting/alerting module. The modules' functionality and ability to communicate the operational condition diagnostics can vary among different models and each model may have different power demands. Nonetheless, all modules are configured to discern the operational readiness of the egress light source and communicate at least once sensed failure to a remote client.

It is noted that each standalone egress light source is a kind of “slave” luminaire, and thus be identified by an ID of the ambient luminaire as its host. Alternatively, the egress light source coupled to an ambient lighting luminaire can have a unique address that can be associated with a digital lighting reflected ceiling plan and/or a floor plan. It is also noted that the reporting/alerting module can be as basic as generating an audio output alert and/or visual output upon sensing a failure, or with the more advanced diagnostic tool, can communicate by wire or wirelessly to at least one remote client at least one of, the specific luminaire location where the failure occurred, identify the root failure cause, the failed part/s code, the repair action required, the repair priority, and the go-to contact responsible for making the repair.

The power generated by the at least one luminaire onboard power generating source is stored by at least one of a capacitor bank, battery (not disposable), and/or a solid-state storage device configured to store power effectively. The power storage device can be configured to store sufficient power to operate at least one of, the egress light source, a microprocessor with or without a microswitch, a communication device, and at least one other sensing device such as a speaker. The functionality of at least one of the above-described devices is contingent upon at least onboard power availability. For example, when the egress lighting system powered by a remote source is under constant load, the testing and alerting modules can partially or fully rely on remote power. Conversely, when the egress light source power conductors are not under constant load, some or all the devices can be powered by locally generated power.

In yet a different configuration, the operation of the testing module and the reporting/alerting module can be configured to operate in unison with one another, wherein power generated locally is used to power certain operational aspects of the testing, reporting, and alerting in accordance with a schedule, while the same or other operational aspects of the testing, reporting and alerting are relegated to power received from a remote source. The conductors of the power received at the luminaire's egress light source can be under continuous load or under the no load until prompted manually or by control code.

The local self-power generating non-addressable egress light source testing and alerting module is the system's most basic means of communicating a fault. The messaging is conveyed by a sensory device output that is received by a building occupant. The fault detection circuit can be limited to at least one of, a photovoltaic cell, a short-term power storage device, a driver, a microprocessor, a first egress light source, and a second sensory device. The second sensory device can be a light source and a speaker. The use of an auditory output device is recommended where building space is obstructed by floor or ceiling suspended obstructions.

At least one circuit configured for testing and alerting a building occupant can operate as follows. Upon reaching a power storage device loading threshold, a testing cycle can commence. Once the cycle begins, power from the power storage device flows through the driver to the light source. If the level of the resistive load is sensed, no further action be taken until the next test cycle. However, if the sensed level deviates from the expected level by more than a predetermined amount (e.g., 10%), the second sensory device is activated. For example, an auditory device can then broadcast an auditory sound that will alert a building occupant to the specific location of the faulty egress light device. The testing cycle can also be triggered by a schedule and/or ignition cycle of an onboard ambient lighting device or any other testing pro-active trigger.

While this basic configuration does not identify the fault's cause and action required to remedy the issue/s, it establishes without dependence on remote power that a fault exists and associates the fault with a specific location within a building, a location that can have a specific address. A more sophisticated version of the above base model configuration can include at least one microprocessor with code and one or more circuits that are configured to provide more granular detection to enable identifying the specific onboard device/s that failed.

The microprocessor is configured by its execution of stored code to test each of the devices alone and/or in unison. When a fault condition is sensed, at least one sound emitting device can broadcast the fault code by sequencing recognizable sound. In addition, at least one indicator LED light source can be turned on, change color and modulate the power output, and/or ignition sequence to alert a failure or alert and identify the nature of the failure.

The duration of the sound broadcasting and/or the LED indicator signal emitted is contingent on the onboard short-term power storage device capacity, the number of devices to be tested, and the power requirement of each tested device, the microprocessor and the output device/s. In at least one embodiment a plurality of power storage devices can be coupled to an ambient lighting luminaire wherein at least one of the plurality of the power storage devices is dedicated to at least one power consuming device coupled to the ambient lighting luminaire or to a housing of an egress light luminaire “slave” that is powered from the ambient lighting luminaire.

The local self-powered generating addressable egress light source testing and alerting modules—The self-powered testing module described above can include an RF communication module. The communication module includes a transceiver that transmits, or transmit and receives, signals from at least one remote client. At minimum, a status signal sent from the RF communication module can be configured to communicate to a remote client a digital fault code. The signals can be conveyed by any of a variety of wireless protocols such as BlueTooth, Zigbee, WiFi, WLAN, or any other secured RF signal communication protocol. The signal can be conveyed by wire and/or wirelessly directly or indirectly to a building environmental systems controller. In at least one same or different embodiment, the controller can be the remote power source controller of egress lighting.

The addressable testing and reporting/alerting modules of the egress light source can be configured to couple to a plurality of sensory devices that can also monitor the environment where the egress light source is located for occupant safety and security. Coupled to a code driven processor, the monitoring can be continuous or intermittent at least when the power used is generated by an onboard ambient lighting luminaire. The code can include at least one AI algorithm that is configured to minimize power usage by applying logic to environmental input received.

Further, when mesh network communication is used (e.g., IEEE 802.11s), the strength of the signal transmitted can be weak as the signal between one luminaire with an egress light source and another does not need to travel far. The present innovation's communication module can send at least one signal to a remote client directly, via a meshed network, directly to a relay that communicates with a remote client, or via meshed network that transmits by relay the signal to the remote client. The signal transmitted from the testing and reporting/alerting modules of the ambient luminaire with an egress light source or the standalone egress luminaire can be as detailed as required and can be supported by the limited power storage available onboard.

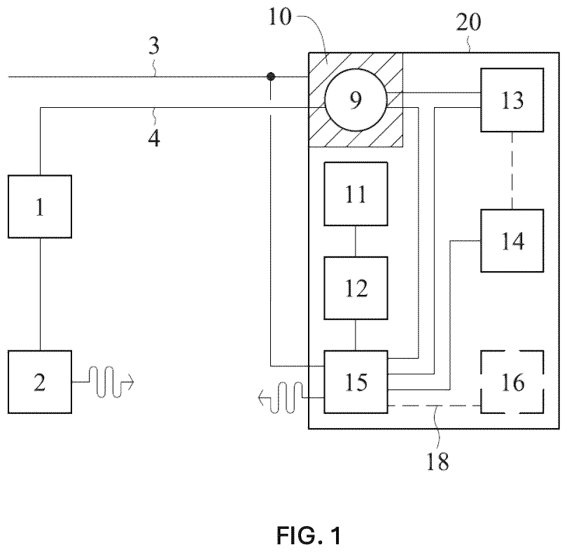

FIG. 1 is a diagram of a power and monitoring system for an ambient light source 10, with BIT capabilities for monitoring continuously available power and functionality of an egress light source 9 included as part of the ambient light source 10, or attachable to the ambient light source 10. The ambient light source 10 receives power from a house power conductor 3 (conductor in this context means one or more wires that deliver electricity used for powering a device), which provides general power for operating all of the components of the ambient light source 10. The present embodiment shows house power also being received by the processor. The processer is configured to discern the power source and where applies include a stepdown transformer. The egress light source 9 also receives power from a remote power source 1 that is connected to a communications module 2 which engages in wireless communications with a processor-based controller 15 (e.g., processor circuitry that is configured by execution of software code) having a wireless communication capability. Inside the ambient light source 10, a BIT module 13 (built-in-testing circuitry) performs different status tests on the egress light source 9, power conductors, etc., as will be discussed in more detail later. The BIT module 13 is connected to a reporting/alerting module 14 (reporting/alerting circuitry) which provides the processor/controller 15 with the information needed for the processor/controller 15 to generate a status message that includes an ID of the light source, as well as any error code or fault code that identifies the nature of a detected problem with one or more components. Also, the reporting/alerting module 14 may generate the information for an optical and/or auditory alert produced by a sensory output device 16 so a person in the vicinity of the ambient light source 10 will be made aware of the problem via an audio and/or visual emission. For example, the sensory output device 16 may include a LED (e.g., Red LED that is controllable to flash in different patterns) and speaker.

As will be discussed in greater detail later, the power storage device 12 (power storage circuitry) may include a highly reliable and maintenance free capacitor bank, with an optional battery. The power generation device 11 (power generation circuitry), in this embodiment, is photovoltaic circuitry that collects ambient light and converts it into electricity, which is used to charge the capacitor bank and battery. This self-generation of power is valuable if other power is unavailable via conductors 3 and 4, or there is a physical problem (e.g., cut conductor cable) with the delivery of house power, and backup power from the remote source.

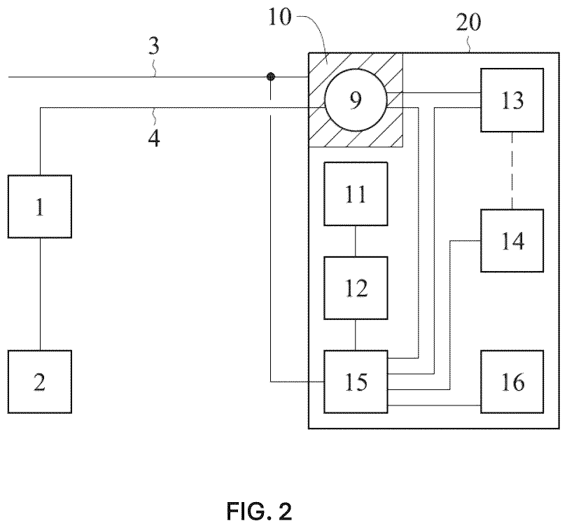

FIG. 2 is a system diagram of a variation of the system shown in FIG. 1. Instead of wireless communications between the communication module 2 and processor/controller 15, the primary error reporting mechanism is the sensory output device 16. For example, when a fault is detected, a speaker can broadcast an audio signal. The signal can have an audible pattern that an educated ear can tell the nature of the fault. No matter what the audio signal communicates, the signal identifies the location of the faulty egress light source device. Similarly, Colored LED indicators can communicate by color, switch on/off, and duration the nature of a fault with an egress lighting device. The testing can be independent of remote testing and occur periodically to discharge at least a portion of the power generated and stored onboard the ambient lighting luminaire.

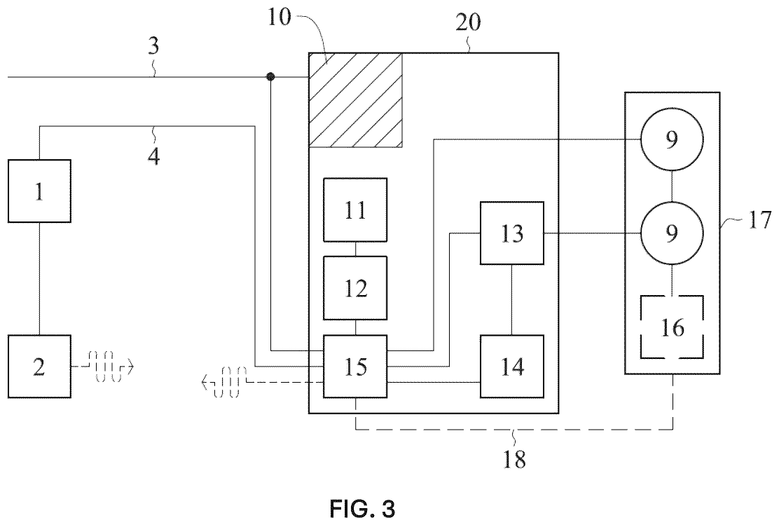

FIG. 3 is a system diagram of another embodiment that varies from the embodiment of FIG. 1, but the egress light source 9 and sensory output device 16 are optionally contained in a separate housing 17 than the ambient light source 10. The egress light source and sensory output device 16 may be connected directly or via a wireless communication module to the processor/controller 15. The present embodiment shows power received at the egress light sources 9 from the processor/controller power management module. The egress light sources 9 are communicatively coupled to a BIT module that can be coupled to an alerting and reporting module 14. A sensing output device can be coupled to the separate housing 17. Power and/or signal to the sensing device 16 can be delivered directly from the alerting and reporting module 14 or through the processor/controller 15. The power connectivity, and perhaps data connectivity as well, of the present embodiment to the sensing device is shown in dashed line 18. The devices contained in the separate housing 17 remain in communication with the BIT module 13 via a wired connection, although a wireless connection may be used as well.

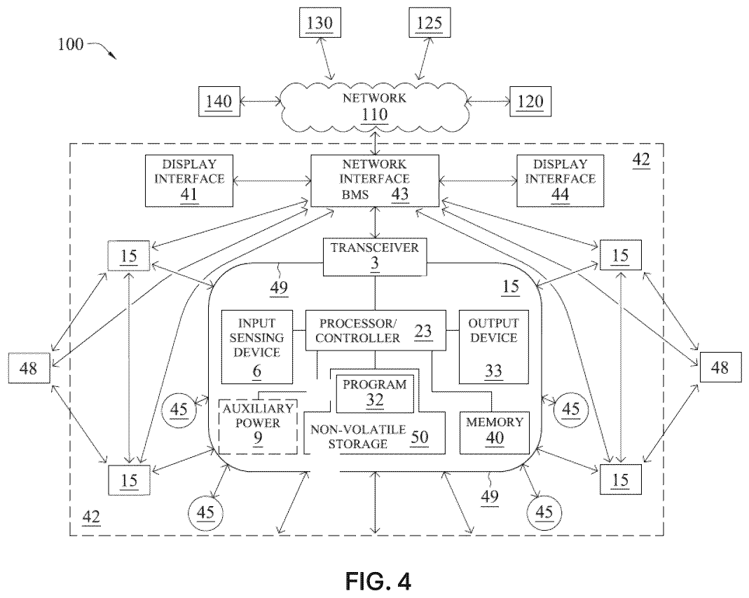

FIG. 4 is a block diagram of a processor/controller (computer)-based network system 100 coupled to an egress light source that may implement the various embodiments described herein in operating the control of the BIT functionality, power monitoring, and fault/status reporting.

FIG. 4 illustrates a control aspect of the present disclosure that may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device (circuitry) from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely autonomously, on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 4 is a functional block diagram illustrating a networked system 100 of one or more networked computers and servers. In an embodiment, the hardware and software environment illustrated in FIG. 4 may provide an exemplary platform for implementation of the software and/or methods according to the present disclosure.

Referring to FIG. 4, a networked system 100 may include, but is not limited to luminaire 15 (which includes computer circuitry as shown), network 110, remote computer 115, web server 120, cloud storage server 125 and computer server 130. In some embodiments, multiple instances of one or more of the functional blocks illustrated in FIG. 4 may be employed.

Additional detail of the computer circuitry included in each ambient light source 10, in reference to FIG. 1, (or separately in the egress light source 9, if not included as part of the ambient light source 10) is shown in FIG. 4. The functional blocks illustrated within the computer circuitry are provided only to establish exemplary functionality and are not intended to be exhaustive. And while details are not provided for remote computers 140, web server 120, cloud storage server 125 and computer server 130, these other computers and devices may include similar functionality to that shown for the computer.

The circuitry may be any programmable electronic device capable of communicating with other devices on network 110. The processing circuitry of luminaire (or BMEL more generally) may include processor 23, bus 49, memory 40, non-volatile storage 50 with auxiliary power storage 9, network interface 43, peripheral interface 44 and display interface 41. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Computer processor 23 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 49 may be a proprietary or industry standard high-speed parallel or serial peripheral interconnect bus, such as ISA, PCI, PCI Express (PCI-e), AGP, and the like. Memory 40 and non-volatile storage 50 may be computer-readable storage media.

Memory 40 may include any suitable volatile storage devices such as Dynamic Random Access Memory (DRAM) and Static Random Access Memory (SRAM). Non-volatile storage 50 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

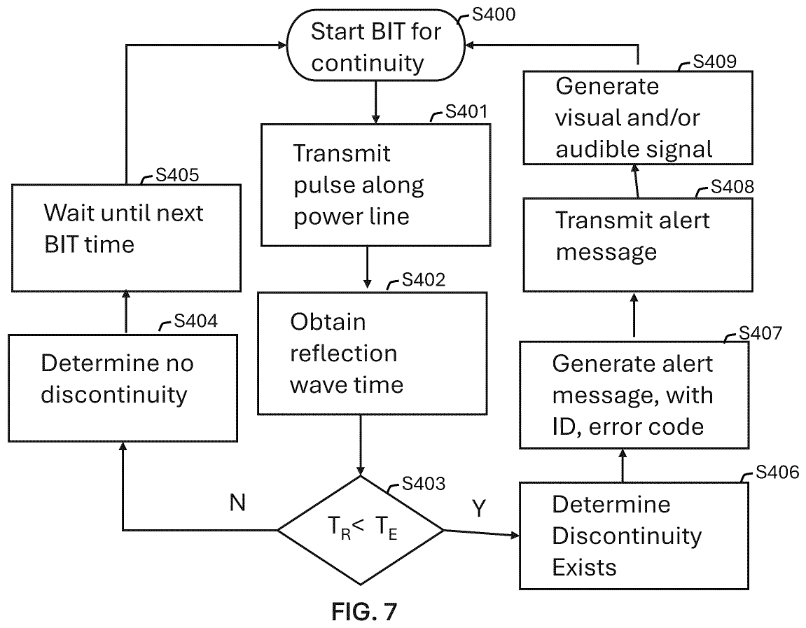

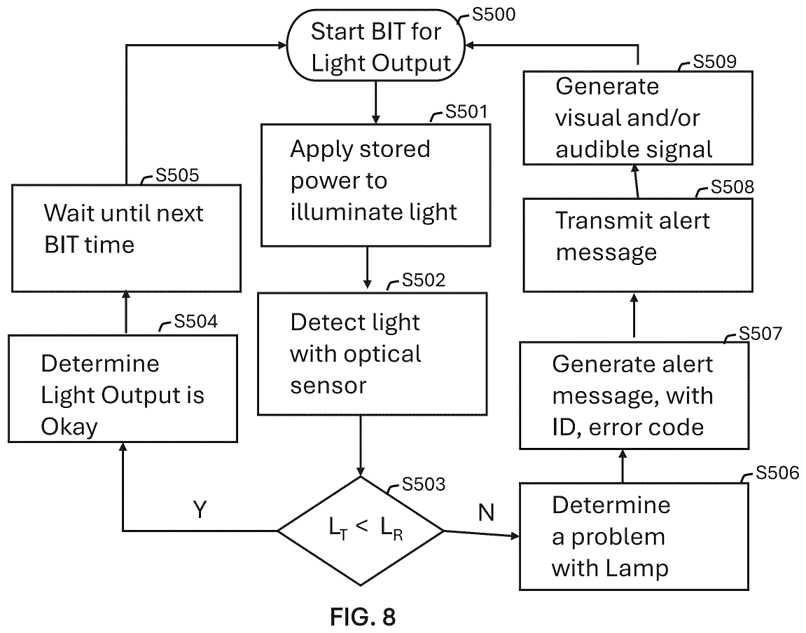

Program 32 may be a collection of machine readable instructions (code) and/or data that is stored in non-volatile storage 50 and is used to create, manage and control certain software functions that are discussed in detail elsewhere in the present disclosure and illustrated in the drawings. In some embodiments, memory 40 may be considerably faster than non-volatile storage 50. In such embodiments, program 32 may be transferred from non-volatile storage 50 to memory 40 prior to execution by processor 23. Two of the software functions are described in the flowcharts of FIGS. 7 and 8, as will be discussed later.

The computer may be capable of communicating and interacting with other computers via network 110 through network interface 43. Network 110 may be, for example, a local area network (LAN), a wide area network (WAN) such as the Internet, or a combination of the two, and may include wired, wireless, or fiber optic connections. In general, network 110 can be any combination of connections and protocols that support communications between two or more computers and related devices.

Peripheral interface 44 may allow for input and output of data with other devices that may be connected locally with the computer. For example, peripheral interface 44 may provide a connection to external devices. External devices may include devices such as a keyboard, a mouse, a keypad, a touch screen, and/or other suitable input devices. External devices may also include portable computer-readable storage media such as, for example, thumb drives, portable optical or magnetic disks, and memory cards. Software and data used to practice embodiments of the present disclosure, for example, program 32, may be stored on an egress luminaire such portable computer-readable storage media. In such embodiments, software may be loaded onto non-volatile storage 50 or, alternatively, directly into memory 40 via peripheral interface 44. Peripheral interface 44 may use an industry standard connection, such as RS-232 or Universal Serial Bus (USB), to connect with external devices.

Display interface 41 may connect the computer to a remote display that is able to display an electronic building plan. The electronic building plan includes a display with different BMELs located on the plan according to their locations (and addresses/IDs) in the building, and the respective operational statuses of the BMELs (e.g., standard operational mode, or degraded operational mode). The remote display may be used, in some embodiments, to present a command line or graphical user interface to a user of computer. Display interface 41 may connect to the display using one or more proprietary or industry standard connections, such as VGA, DVI, DisplayPort and HDMI.

As described above, network interface 43, provides for communications with other computing and storage systems or devices external to the computer. Software programs and data discussed herein may be downloaded from, for example, a remote computer, a web server 120, a cloud storage server 125 and a computer server 130 to non-volatile storage 50 through network interface 43 and network 110. Furthermore, the systems and methods described in this disclosure may be executed by one or more computers connected to the computer through network interface 43 and network 110. For example, in some embodiments the systems and methods described in this disclosure may be executed by remote computer 115, computer server 130, or a combination of the interconnected computers on network 110.

Data, datasets and/or databases employed in embodiments of the systems and methods described in this disclosure may be stored and or downloaded from remote computer 115, web server 120, cloud storage server 125 and computer server 130.

FIG. 4 further shows a diagram of the building means of egress device connectivity. The present embodiment shows the entire device network 100 of the building means of egress constructed with as few as two communicatively coupled egress luminaires having controllers 15. For this reason, a controller/processor 15 for a luminaire is shown at the center of the present block diagram. The controller/processor may include a processor/controller 23 (computer processor), an input sensing device, an output device 33, a transceiver, and an auxiliary back-up power supply.

The controller/processor 15 for a luminaire is disposed inside a building interior 42. Inside the building, the egress luminaire is in communication with at least one more controller/processor 15 for a luminaire and may also be communicatively coupled to at least one other building discipline device 45. In addition, at least one controller/processor 15 for a luminaire can be communicatively coupled to at least one exterior mounted device 48.

The network interface 43 can be communicatively coupled to the cloud network 110 and through this network, can be communicatively coupled to at least one of: a remote computer, a web server 120, a cloud storage server 125, and a computer server 130.

The remote power source 1 (FIG. 1) transmits power to egress light sources downstream only when house power is interrupted (or during testing) and can be programmed to test the power connectivity to the egress lighting light sources on a routine basis. Each testing module at the egress light source can be configured to identify a failure by light source location and/or address. The means to identify a failed light source location can be by at least one of a local sensory output and a signal communicated to at least one remote client.

At least one device that powers the testing and reporting/alerting modules receives power that has been generated by an onboard ambient lighting light source. Most importantly, the reporting/alerting module coupled to the egress light source can be configured to alert at least one client when power connectivity from the remote power supply to the egress light source is lost.

In at least one power distribution configuration, the conductors delivering power from the remote power source to the egress light source can be under load. In such a power distribution configuration, microswitch/es onboard the luminaire can turn the egress light source on and off. The microswitch can be controlled by an onboard processor controller and/or by a remote processor controller via a transmitted signal. When house power is interrupted or during a test cycle, at least one remote controller (a master controller) directs at least one addressable egress light source to turn on. If the light source does not turn on, a signal is communicated back to the at least one of the controller initiating the test and at least one additional client.

It is noted that even though the power distribution configuration described above maintains constant power to the egress light source, it is conceivable that power connectivity between the remote power source and the egress light source can be disrupted, and a self-powered onboard reporting/alerting module is needed to report the disconnection.

Finally, the egress light sources are located over the main circulation paths within a building. The present egress lighting system receiving power from remote back-up power source can provide other utility by at least operating as a building night light. The egress lighting controller can enable the flow of house power to at least one egress light source when house power is available. The house power bypasses the back-up power source. When house power is interrupted, the egress lighting controller switches to the back-up power source. The controller can also direct the egress light sources to dim. However, when house power is interrupted, the egress light source are re-set to full output.

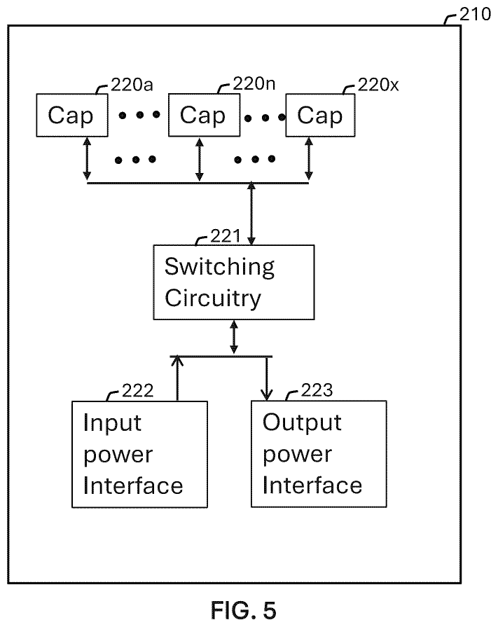

FIG. 5 is a capacitor bank 210 that is used as a local backup power source and is designed to store electrical energy temporarily and released when needed. The capacitor bank 210 includes a plurality of capacitors 220a to 220x, with perhaps only a fraction of them used at one time (e.g., 220a to 220n), while the others used as on-board spares, or are switched in when extra capacity is needed.

The physically and electrical sizing of the capacitor bank may be adjusted according to the circuit demands, and may be set according to the equation E=P×t, where E is the energy in joules (J) needed to supply the power for the specified time, P is the average power in watts (W) that the capacitor bank needs to provide, and t is the duration in seconds(s) for which the capacitor bank needs to supply this power. For typical egress lights, the power consumption is roughly 6 W each, and 24 W for 4 of such lights and related circuitry such as drivers, switching circuitry, processors, etc., Thus, to provide 24 watts of power for at least 1 second, E=24 W×1 s=24 joules (J). The capacitance (C) needed to store this energy can be found using the formula: C=(2×E)/V², where C is the capacitance in farads (F), E is the energy in joules (J), and V is the voltage rating of the capacitors. Thus, at 100V, C=(2×24 J)/(100 V)²., or 0.0048 F, which is 4,800 μF.

In terms of the physical sizes of the capacitors to provide 4,800 μF, various formats may be used. For example, 1,000 UF electrolytic capacitors are about 0.75 inches in diameter, and 1 inch in length. When 6 all are arranged in a 2×3 grid on a single side of a PCB, the combined capacitance is 6,000 μF, and the footprint and volume of the capacitor bank is roughly 1.5″×2.25″×1″.

On the other hand, only 1,200 μF of capacitance is sufficient to support 0.25 seconds of illumination of the egress light's LEDs and drivers, which can be supported by 12 100 μF electrolytic capacitors at 100 V. Each 100 μF typically is 0.4 inches in diameter and less than 0.9 inches in height. When all are arranged in a 4×3 grid on a single side of a PCB, the footprint and volume of the capacitor bank is roughly 1.6″×1.2″×0.9″. If mounted on both sides of the PCB in two 2×3 grids, the size is roughly 0.8″×1.2″×1.8″.

The above configurations are merely exemplary, and different timings (e.g., 1/10 of a second), and different sized capacitors may be used according to these teachings so that enough light is emitted for a sufficiently long period of time that a remote sensor can detect the level of output light. Alternatively, or complementarily, the drive currents may be monitored as a proxy for monitoring the output light from the egress lights.

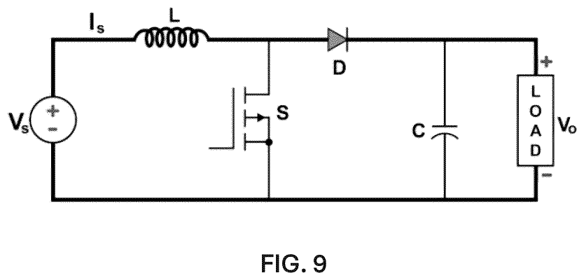

In FIG. 5, the input power interface connects to switching circuitry 221 (which includes control circuitry, such as the boost circuitry of FIG. 9). The switching circuitry 221 includes controllable switches (e.g., semiconductor switches and/or relays) that are used to connect and disconnect the capacitor bank from other circuitry that serves as a load (e.g., the LEDs and drivers). This control circuitry can be discrete circuitry or programmable circuitry for controlling the switching operations and monitoring the voltage levels on the capacitors.

During a charging operation, the switching circuitry 221 connects the capacitors 220a-220n to a power source (e.g., photovoltaic circuitry, and/or inductive circuitry that parasitically draws power from the primary or back up power lines) to charge the capacitor bank via a trickle charger that regulates the charging current to prevent overcharging and ensure the capacitors reach their intended voltage safely and efficiently.

During discharging, the switching circuitry (which may be implemented by the processor) rapidly activates the switches to allow charge stored in the capacitors 220a-220n to drive other circuitry (as a load). The switching circuitry 221 includes a microcontroller that controls the charging based on inputs from sensors and user-defined parameters. This control logic manages, timing, protection, and efficiency. The timing determines when to switch between charging and discharging modes based on system demands and energy storage levels. The microcontroller monitors voltage levels to prevent overcharging or over-discharging, which can extend the lifespan of the capacitors and ensure safe operation. The efficiency optimizes the switching process to minimize energy losses and maximize the efficiency of energy transfer from the power source to the load.

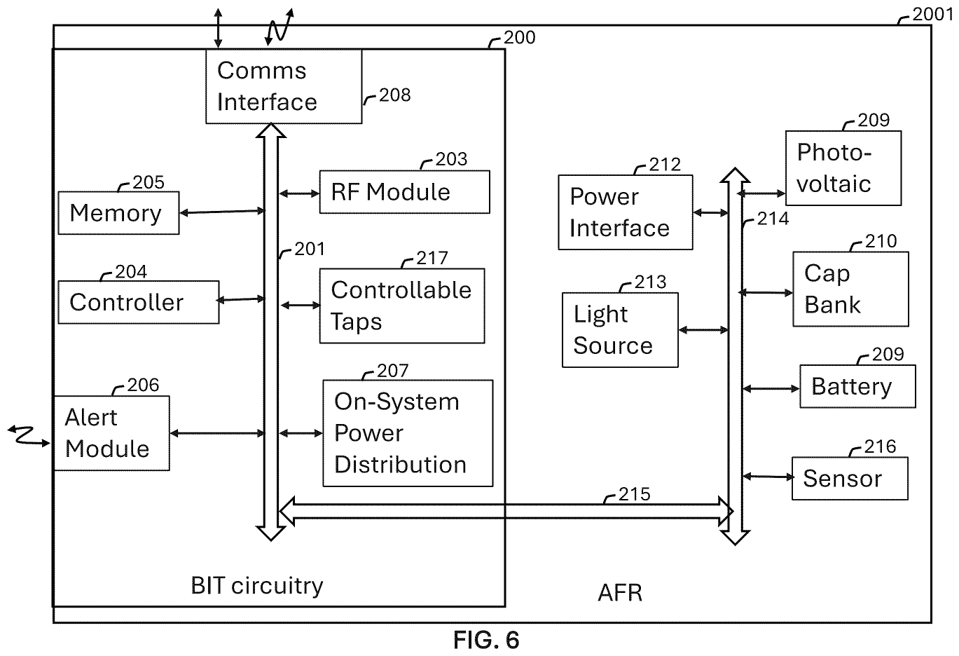

FIG. 6 is a block diagram of the BIT circuitry 200, which is part of self-power generated adaptive failure reporting (AFR) circuitry 2001, discussed in more detail later. A bus 201 interconnects various components, including a controller 204, like that described in reference to FIG. 4. The controller 204 may be programable (e.g., CPU, GPU, or the like), or dedicated circuitry (e.g., ASIC). The controller 204 executes code stored in memory 205 and performs operations like those described later in reference to FIGS. 7 and 8. The controller 204 generates status messages or alert signals to remote and/or peripheral devices regarding BIT results. Moreover, the status message may include an ID of the light source 213 that the BIT circuitry determines is experiencing an error condition, as well as an error code that identifies the nature of the problem. For example under a condition the BIT circuitry 200 determines a power line is disconnected and prevents power from reaching light source 213, the BIT circuitry prepares and sends via the RF module 203 (which contains a wireless transceiver) and communications interface 208 a wireless signal reporting the ID of the light source 213, as well as the error codes (e.g., disconnection, and failure to generate light). This way, the message can be received by a remote computer that monitors the conditions of the lighting network, and can dispatch a repair message for someone to repair the light. The BIT circuitry 200 may also issue a message over a wired communication channel if one exists. Likewise, the controller 204 can prepare an optical and/or auditory alert via alert module 206.

The controller 204 also controls controllable conductivity taps 217 that allow for isolated conductivity taps points between different components shown in FIGS. 1-2 and 6. On-system power distribution circuitry 207 operates under control of the controller 204 and under a condition primary power is detected as being absent, or the BIT circuitry 200 operates a BIT routine, the on-system power distribution system 207 switches in/out power sources to the components under test, or in the case of back-up power, providing backup power from a secondary source such as the battery 209 for back up operation. A power/data interconnect bus 215 interconnects the bus 201 on the BIT circuitry 200 with a power/data bus 214, which is external to the BIT circuitry 200. The power/data bus 214 connects to a power interface 212, which provides primary power to the egress light source 213. However, in the event primary power is unavailable, the testing of the egress lights may continue to be checked while being powered from the capacitor bank 210. A photovoltaic device 209 converts ambient light during normal operations into electricity that is used to keep the capacitor bank 210 charged, as well as the battery 209 charged. An optical sensor is positioned to receive light emitted from the egress light source 213 during a BIT test of the light emitted from the light source 213. If the light is below a predetermined level (e.g., 80% of an expected light level), the detection signal from the sensor 216 is provided to the controller 216, which issues a status message with the ID and error code.

The built-in-test (BIT) circuitry 200 is designed to test the functionality of the subcomponents and especially whether power has been disconnected to a lighting device. It operates with the goal of detecting the absence of electrical power. and signaling this condition to external monitoring systems. For present power detection, the BIT circuitry is integrated within the lighting device and continuously monitors the presence of electrical power supplied to it. The BIT circuitry includes voltage sensors or current detectors that measure the voltage level at the input terminals of the lighting device, or current flow through the device. However, if the power line is not energized, the BIT circuitry includes conductors or probes that are in contact with the non-energized power line. These components are used to sense the continuity of the lines. When the non-energized power line is intact and connected, there is typically a low resistance path between the conductors or probes. The BIT circuitry can measure this resistance to confirm continuity. The circuitry is set to detect a specific resistance threshold that indicates the presence or absence of continuity in the line. For example, a very high resistance (indicating an open circuit) would suggest that the line has been disconnected. Upon detecting a resistance above the threshold level (indicating an open circuit), the BIT circuitry generates a signal or changes its state to indicate a disconnection condition. Similar to power loss detection, the BIT circuitry may activate an indicator such as an LED indicator light or send a signal to a monitoring system. This alerts maintenance personnel or users that the non-energized power line has been disconnected. Moreover, the BIT circuitry communicates (wirelessly, via a wired connection, of via an optical or audible signal) with centralized control systems or building management systems (BMS), or even a human who can hear and see the fault condition. It can report the fault condition, enabling proactive maintenance and troubleshooting.

FIG. 7 is a flowchart of a continuity BIT process performed by the controller 204 and associated circuitry previously described. Prior to performing this continuity BIT process, the BIT circuitry checks for whether the backup power is reliably provided via backup power conductor 4 (see FIG. 1). Moreover, the BIT circuitry 200 (FIG. 6) performs periodic voltage checking processes where a voltage potential is measured on line 4 with respect to ground, and if backup power is applied at a predetermined voltage level, then the BIT circuitry 200 concludes the backup power is working sufficiently well. An optional current check may be performed as well. In some situations, the power may not be applied and there is a question about whether the conductor 4 is intact. In some situations, the conductor 4 may be provided with a ground wire in addition to a conductor wire and so a conductivity test (by taking a resistance measurement via the controllable taps 217 that connect to the conductor 4 and ground wire) can be performed to see if the conductor remains electrically connected to the remote power source 1 and the egress light source 9. However, if the remote power source 1 is disconnected and there is no ground wire present, the BIT circuitry 200 cannot determine by a conductivity test whether the back-up power conductor 4 has be broken or not. In this case, the BIT circuitry 200 performs a time domain reflectometer (TDR) test.

Moreover, the BIT circuitry 200 is equipped to detect a break in the power line 4 via its generation of a signal (e.g., pulsed waveform) that is sent down the power line 4. When the signal encounters an open circuit or discontinuity in the line, a portion of the signal reflects backward towards the source due to a lack of termination. The reflected signal carries information about the impedance of the line or circuit at the point of discontinuity. By analyzing the amplitude, phase, and timing characteristics of the reflected signal, the controller 204 can deduce the presence of an open circuit. The BIT circuitry employs a TDR to send short pulses down the power line 4, and measure the reflection time to return. An open circuit (e.g., a cut power line) appears as a sudden spike in the reflected signal. Based on the analysis of the reflected signal, the BIT circuitry generates an alert signal (with information such as an address of the device and an error code) to trigger a maintenance action. In turn, this allows for proactive maintenance by detecting potential issues before they lead to complete failure.

FIG. 7 is a flowchart of a BIT for continuity on the backup power line 4. The process begins at S400 and the controller 204 generates a pulse that it provides to power interface 212 (FIG. 6) to apply to power conductor 4 (FIG. 1). The controller 204 observes a time delay before a reflection is received. In step S403 the controller checks whether the received time TR time is less than an expected time TE. If the result of the inquiry is negative, the process proceeds to step S404 where the controller determines there is no discontinuity, and then after waiting for another time (e.g., 1 hour) in step S405, the process returns to step S400 where another BIT continuity test is performed.

However, if the result of inquiry in step S403 is affirmative, the controller concludes in step S406 that the discontinuity exists and the process proceeds to step S407 where the controller generates an alert message identifying the luminaire for which the test was performed, and an error code that identifies the nature of the detected problem. The alert message is transmitted in step S408 to a remote computer so a maintenance action can be taken to repair the discontinuity. Subsequently in step S409, a visual strobe light and/or an audible signal may be generated so error status may be detected by a person who is in the vicinity of the luminaire. Steps S408 and S409 can be performed in a single processor, or the process can adopt just one of the steps (i.e., either send a wired or wireless message, or generate visual and/or audible signals).

FIG. 8 is a flowchart of a BIT process to detect whether an amount of light coming from the egress light source is sufficient according to its purpose. The process in FIG. 8 detects an amount of light coming from the egress light source. However, a proxy test is optionally performed as well, where a current draw from the capacitor bank is observed and compared with an expected current draw if the lamps in the egress light source is operating properly.

The BIT process in FIG. 8 starts in step S500 and proceeds to step S501 where energy stored in the capacitor bank is applied as a current flow to drive the lamps (e.g., LEDs and drivers) in the egress light source for a predetermined period of time (e.g., 1 second, or ¼ of a second). The light emitted from the lamps is then detected with an optical light sensor in step S502. An inquiry is made in step S503 to determine if the received light LR is greater than a threshold light level LT. If the response to the inquiry in step S503 is affirmative, the process flows to step S504 where the controller makes a determination that the light output is sufficient, and then the process waits in step S505 until the next BIT process is started in S500.

However, if the response to the inquiry in step S503 is negative, in step S506 the controller determines that there is a problem with the egress light source. Subsequently, the controller generates an alert message in step S507 where the message includes an ID of the egress light source that has the low detected light output, and an error code that is associated with the nature of the problem that is experienced. In step S508, the alert message is transmitted (via a wired connection or via wireless) to a remote device so a maintenance action may be taken. Optionally, in step S509 the controller causes a visual and/or audible signal to be generated so a person in the vicinity of the egress light source can be made aware of the problem.

FIG. 9 is a boost converter circuit for boosting the DC power provided from a photovoltaic circuit to a higher voltage held by the capacitor bank. The boost converter, also known as a step-up converter, is a DC-DC converter that increases the input voltage to a higher output voltage. The components of the boost converter include an inductor (L) fed from a voltage source that with a current Is. The inductor L feeds a switch (transistor, S) in parallel, as well as a diode D, in series. A capacitor is placed in parallel with a load over which the output voltage V₀ is developed. The operation of the boost converter includes two main stages: On state (switch S closed), and Off state (switch S open). When the switch is closed, current flows through the inductor, causing a magnetic field to build up and storing energy in the inductor. During this period, the diode is reverse-biased (not conducting), and the load is powered by the capacitor. The voltage across the inductor increases linearly over time due to the constant input voltage. When the switch is opened, the inductor's magnetic field collapses, and the energy stored in the inductor is released. The inductor's voltage polarity reverses, and it adds to the input voltage, effectively boosting the voltage. The diode becomes forward-biased, allowing current to flow to the capacitor and the load. The capacitor smooths out the voltage, providing a stable output voltage. The duty cycle of the switch (the ratio of the time the switch is on to the total period) plays a critical role in determining the output voltage. For a high output voltage like 100V from a 10V input, the duty cycle will be high, which in this case is a 90% duty cycle. The relationship is given by:

V₀=Vs/(1−D), and thus 100=10/(1−D) when D−0.9

The controller 204 (FIG. 6) can optionally serve as a pulse width modulation (PWM) controller to adjust the duty cycle to maintain a settable output voltage. The PWM controller senses the output voltage V₀ and sets the modulation rate of the transistor S accordingly. A feedback loop ensures that the output voltage remains stable despite changes in input voltage or load conditions.

### Adaptive Failure Reporting (AFR) During Progressive Power Failure

As a variation on the above described embodiments, the focus in the following paragraphs is on self-power generated adaptive failure reporting (AFR) circuitry that adapts communications based on available, and planned, power as the power progressively fails. This solution is targeted for testing readiness of a building illuminated means of egress (BMEL, a smart, self-reporting lighting apparatus as described herein). The AFR solution's self-diagnostic enables an egress lighting device to communicate sensed faults in absence or with insufficient power available from an integral or remote power source. In this context, integral power refers to disposable batteries, and remote backup power refers to power that arrives from a remote source (e.g., generator and inverter). Power for the processor operating the BIT module and the communication device is reserved under all power conveyance fault conditions to inform at least one remote client of a last sensed BMEL device failure. In this context the BIT module is part of the AFR solution, in that the BIT module detects the failure, and the AFR's programmed processor (processing circuitry configured by execution of code stored in memory) determines at least one of the size of the reporting message, the content of the reporting message, the radiated power of the reporting message, the frequency at which the reporting message is repeated, or whether to include a request to other BMEL's in the building to serve as a relay for the failed/failing BMEL after the failed/failing BMEL is no longer able to transmit, or the desired attributes (power, message length, frequency) of the transmissions is not supportable by remaining available on-board power.

The present disclosure describes several novel aspects of the BMEL's AFR architecture connectivity with at least one remote client.

The AFR's system architecture can include at least one self-power generating device, a sensing device, a processer/controller with memory, code that can include at least one AI algorithm, an output device, and a communication device. In at least one embodiment output/s or outputs/inputs from a BIT module, controlled by the AFR's processor, and coupled to a BMEL can communicatively couple to at least one remote client.

The remote client can be at least one remote controller coupled to a communication device, a like or different egress lighting device, a lighting device that is not an illuminated egress lighting device, a non-related to egress lighting device such a building HVAC apparatus, a building security system, power consuming input and/or output device/s, and/or a client that is physically remote from a building such as a first responder. The means of communication can be by wire or by wireless employing at least one communication protocol and communication protocols interfaces where needed. The protocols can be adapted for point-to-point and/or meshed network communication (e.g., IEEE 802.11s, WLAN).

Each one of the illuminated means of egress with the BIT module can have an electronic address. At least one of the power consuming devices coupled to the BIT's module system architecture can have an electronic sub-address. That sub-address can be associated with the BIT module prime address of the BMEL. A plurality of BMELs can populate a building with each one of the BMELs having a unique prime address. At least two of the BMELs can be communicatively coupled with one another and/or through a remote client.

The processor/controller of the BMEL and other related coupled power consuming devices can draw power directly from the house power under normal power conditions and under normal back-up power. The dedicated power storage device of the BMEL is configured to be reserved for the “last gasp” operation when normal house power and back-up power is insufficient or not available. Aside from direct house or back-up power line connectivity, an onboard BMEL non-connected power generating device can charge the BMEL's power storage device by means of at least one of a photocell and an induction coil, which are parasitic off of the electricity from the house power. Once the house power is terminated the residual energy earlier produced by the photocell and/or induced power remains available as it stored earlier in a power bank.

At least one remote client controller communicatively coupled to a BMEL can display the locations of a plurality of BMELs on an electronic plan. The BMEL with the BIM module can also alert/report to a remote client on at least one addressable device and/or a system failure. The BIM module of the decentralized onboard processor/controller can identify a BMEL faulty device/system element location on at least one remote client display. A building attendant receiving the alert/report of a faulty device/system element including the specific location of the faulty device/element within a building can then if needed proceed immediately with the repair work.

The remote client processor/controller code receiving the alert/report from a BMEL can have stored data pertaining to each BMEL device components. The data can include at least one of, the OEM component model, cost, where to obtain a replacement, a service contact, and a component warranty disclosure. In addition, the remote client processor code identifying the BMEL fault can generate a repair instruction for a repair person and/or refer a repair person to an operation and repair manual.

In describing the present-day problem, the disclosure has listed several power consuming devices and system elements that are configured to convey power to the BMEL that their failure can adversely affect the operational readiness of the BMEL. Today, the art of building illuminated means of egress is agnostic to most device and system elements fault types. At best, today's art is configured to identify a local device failure by means of an illuminated indicator and/or by an audible alarm. Furthermore, today's central monitoring systems can inform an attendant of remote failures when a plurality of building illuminated means of egress fail; however, these systems lack the capability to identifying the failure locations and the nature of the failure.

The present innovation includes continuously testing the operational readiness of at least one of the BIT module coupled devices and power connectivity to these BMEL devices. The input/s received from the BIT module are analyzed and if a fault is detected, the processor's communication module alerts/informs the at least one remote client of an at least one detected fault. The BMEL code and/or resident code of the remote client processor can assign priority for addressing the fault code received. To reduce traffic line noise, in at least one embodiment the code can be distributed between the BMEL and the remote client, wherein for example the BMEL code sends a fault code and the remote client can show means and methods for issue resolution.

The remote client processor/controller receiving a fault code from an addressable remote mounted BMEL can have stored knowledge of at least two networked devices that are communicatively coupled with their respective components. One aspect of the remote client processor/controller's operation is upon receiving the addressable device fault code, the processor's code can configure the failure cause/s, the parts needed for a repair, can provide the repair instructions, can inform the need to know personnel of the event, and can inform an attendant on the corrective priority level.

The AFR's module processor/controller can be configured to identify a plurality of failure types. These failure types can be categorized by threat level to humans and property. For example, a temperature rise in a device beyond an OEM's allowable threshold may predict an accelerated device failure requiring scheduled repair work. A light source that fails to turn on may require an immediate unscheduled repair. It is noted that a AFR module processor/controller can identify an addressable failed BMEL device and/or a system element and with at least one embodiment can also identify a sub-component of the same failed device.

The AFR processor/controller code—The code operating the AFR module can be configured to provide at least one remote client with at least one of the following data points and fault error codes:
a. A device electronic prime address identification
b. At least one other power consuming device sub-address is associated with a power consuming device with a master address
c. Generate notices and alarms including:
   1. House power—power disconnect to at least one AFR module and/or a local power storage device
   2. House power—power disconnect between the AFR's module processor and at least one power consuming device electrically coupled
   3. Back-up power—power disconnect to at least one AFR module and/or a local power storage device
   4. Back-up power—Power disconnect between the AFR's module processor and at least one power consuming device electrically coupled
   5. Power generation to a power storage device failure
   6. Power storage device failure
   7. Light source failure
   8. Driver failure
   9. Sensory device failure
   10. Code failure
   11. Communication device failure
   12. Processor/controller failure
   13. Operational deviations from OEM general operational parameters
   14. Ambient temperature outside operational limits

The processor/controller operating the BIT module code can be configured to receive inputs from at least one remote client processor/controller and/or at least one or more BMELs that are part of the same system (e.g., different BMELs may be installed over aisleways in a store or building). In at least one embodiment, the remote client processor/controller receiving inputs from an addressable BMEL can control certain operational aspects of the BMEL.

For example, receiving real time inputs from a plurality of BMELs about environmental conditions in contiguous areas within a building, the remote client processor/controller can alter a direction of at least one egress light and/or direction egress signage chevron, thus altering a path of egress from a building. In another example, the remote client processor/controller can direct the light emitting apparatus to broadcast a message while other such light emitting apparatus can remain silent.

It is noted that coupling more sensing devices with different sensing capabilities to the BMEL processor/controller code can enhance the remote client controller/processor that receives input/s from at least one BMEL to protect life and property. At least one of the BMEL's processor/controller code and the remote client processor/controller code can operate a plurality of AI algorithms.

The code can include at least one self-learning algorithm. The self-learning algorithm can be trained to learn the environmental ambient conditions at its installed location and can include all activities within its immediate vicinity. The input/s to at least the remote client processor/controller can be received from at least one BMEL, a sensing device coupled to or detached from a light emitting device, a human and/or a machine, other building environmental systems with connectivity, other building safety and security systems with connectivity, and programmatic parameters and data tables that can be at least in part stored onboard. The programmatic parameters and data tables can also be conveyed to at least one remote client processor/controller on an as needed basis including in real time.

The code's logic can be trained to make logical decisions for at least one BMEL under all building environmental and operational conditions. The decisions can include employing predictive algorithms that anticipate an action before it occurs and intervening to avoid such an occurrence. For example, a processor/controller operating AI code has received real time input from a coupled sensing device that a legal path of egress is blocked by a fallen structure. The processor's code can re-direct a building occupant to a different path of egress while alerting remote client/s to take at least one other action. The code can be trained to understand priorities based on multiple building environmental conditions. Trained properly, the at least one of the BMEL and the remote client codes can operate an BMEL device by descending orders of priorities based on real time inputs locally generated alone and/or in communication with other networked devices.

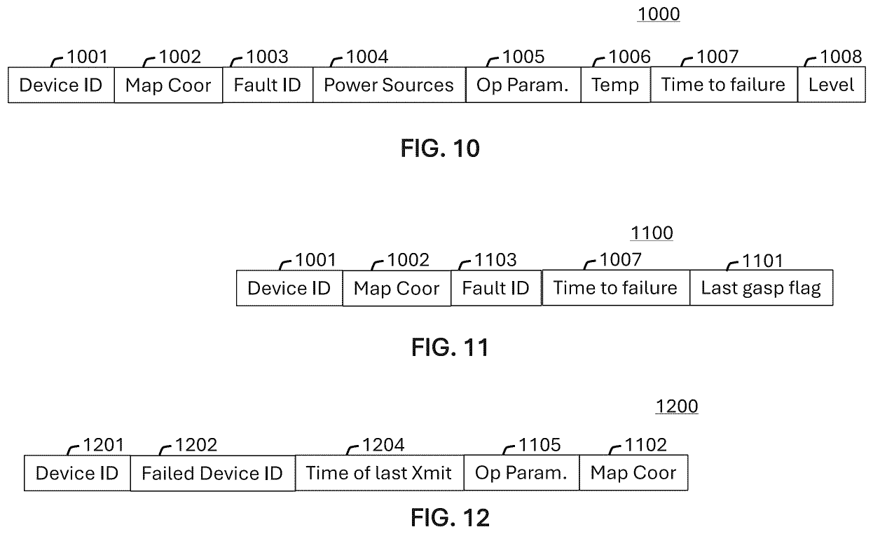

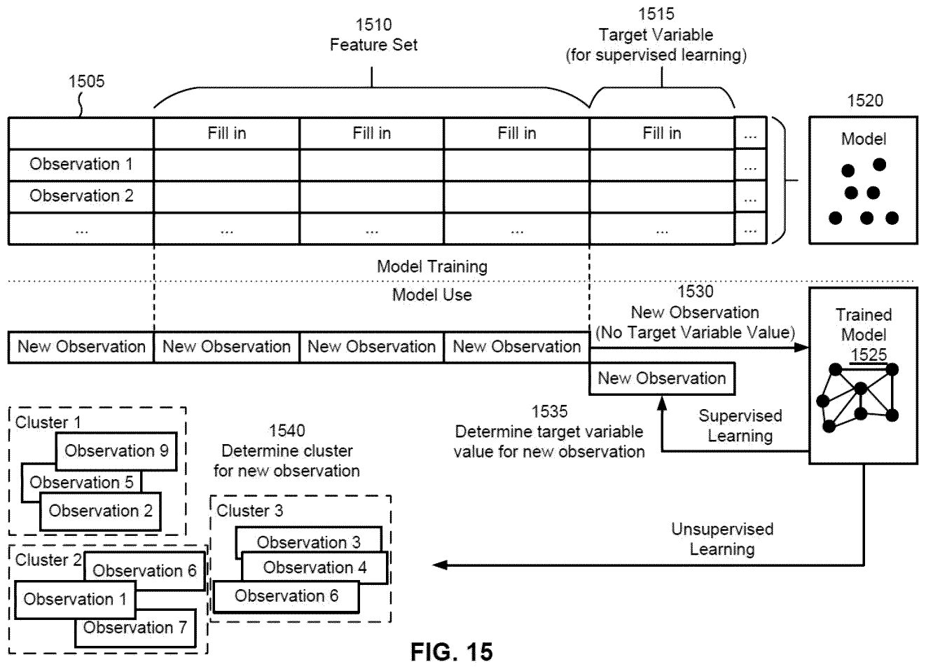

In reference to the hardware of FIG. 4, FIG. 10 is a data structure of normal status message sent wirelessly, and perhaps via hardwire as well, by a processor 15 (FIG. 15, also described herein as an AFR processor/controller) of a BMEL to other devices, including other BMEL's (see processors 15) in the building 42, as well as outside the building 42 via network 110. The data structure 1000, which is included in the message transmitted from the BMEL, includes message segments that will now be discussed in order. Segment 1001 is a unique device ID for the BMEL that is transmitting the status message. The BMEL is installed at a particular location that is part of a network map of BMELs installed in a building, with each BMEL having a device ID 1001 and map coordinate (an indication of where the BMEL is located within the building that is displayable on a visual map showing a status of each BMEL). The map coordinates for the BMEL are included in the segment 1002. Any fault condition detected in internal testing is reported as a Fault ID in segment 1003. An example Fault ID might be “temperature threshold exceeded 1”, meaning that the internal temperature has surpassed a first threshold. Message segment 1004 includes information describing which power sources are available to the BMEL, including house power, backup remote power, local power, and remaining power (charge level) in on-board capacitor bank 210 (FIG. 5).

Message segment 1005 of the normal status message from the BMEL includes information on various operational parameters such as current draw, charge level, camera status, PV status, visual indicator status, statuses of included hardware such as the processor, codes status (e.g., any algorithms that have seized up, or surpassed a time threshold of a watchdog timer), light status, including light output status, capacitor charging circuitry status (FIG. 9), capacitor status, etc. Message segment 1006 includes data regarding the measured temperature of the BMEL. Message segment 1007 includes an estimated time to failure, which is an indication of much power is available under a power depleted mode to transmit messages before being unable to transmit anymore messages. Segment 1008 is an indication of radiated power budgeted by the BMEL for any messages, which may be an indication to another BMEL that serves as a relay on behalf of a failing BMEL whether the failing BMEL can muster enough radiated power to transmit a message to a central processor that manages the network of BMELs.

When the BMEL processor determines that the available power sources have been reduced to the capacitor bank 210 (FIG. 5) and any parasitic power that might be available via a PV cell energized by ambient light, the BMEL can limit its power consumption by reducing message length, transmission repetition frequency (i.e., the rate at which status messages are repeated), and radiated power. FIG. 11 is a data structure of an abbreviated status message with more limited information than the data structure of FIG. 10. Once the time to failure reaches a level that limits the transmission to one last time, the message is referred to as a “last gasp” message. The data structure of FIG. 11 optionally includes a “last gasp” flag, which includes a bit, or a series of bits, as an indication that this will be the last expected transmission from this failing BMEL. Adjacent BMELs or any BMEL within communication range of the BMEL will recognize the last gasp message either by the flag 1101 or by the information in the time to failure segment 1007.

FIG. 12 is a data structure of a “last gasp proxy” message transmitted by another BMEL on behalf of a failed or failing BMEL. The another BMEL receives the last gasp message and responds by preparing the last gasp proxy message which includes segment 1201 carrying its own ID, as well as segment 1202 which carries information of the failed device's ID. Segment 1204 includes the time of last received transmission from the failed BMEL, as well as optional segments including an operational parameters (segment 1105) and map coordinates (segment 1102).

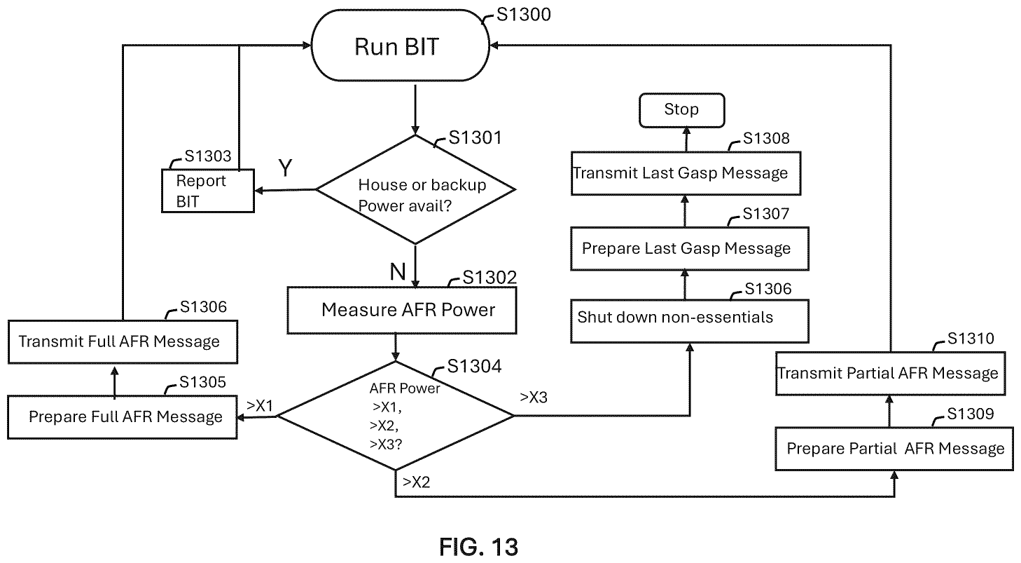

FIG. 13 is an algorithm run by the processor (by execution of stored computer code) of the BMEL. The process starts in step S1300 where the BMEL runs a built-in-test to determine the operational status of components included in the BMEL. The algorithm proceeds to step S1301 where a query is made regarding whether house power or backup power is available. If the response to the query is affirmative the process proceeds to S1303 where a normal status message is transmitted to a central controller for a network of the BMELs in the building. However, if the response to the query is negative, the process proceeds to step S1302 where an AFR power level is measured (on-board power such as via the capacitor bank, but not power from disposable batteries). The processing then proceeds to another query in step S1304 where the power level is compared to a first level X1, a second level X2, and a third level X3. Generally, X1>X2>X3. If the power is greater than X1 the process proceeds to S1305 where a full AFR message (reporting that there is no house or backup power available, but there is ample AFR power for the time being). Then the full AFR message is transmitted in step S1306 and the process returns to S1300. However, the AFR power is determined to be >X2, but less than X1, then the process proceeds to step S1309, where a partial AFR message is transmitted, meaning that less than the full set of segments in the message are included, and/or the transmission repetition rate is dropped, and/or the transmission radiated power is dropped, and/or the error correction coding is reduced so more energy per information bit is transmitted. Then in step S1310 the partial AFR message is transmitted. If the inquiry in step S1304 indicates the power is only above the lowest threshold, X3, the process proceeds to step S1306 where the processor shuts down non-essential components, uses what energy it can gather from ambient light, for example, and/or the capacitors, and prepare a last gasp message in step S1307. In the last gasp message, flag 1101 (FIG. 11) is set, and then the last gasp message is transmitted in step S1308.

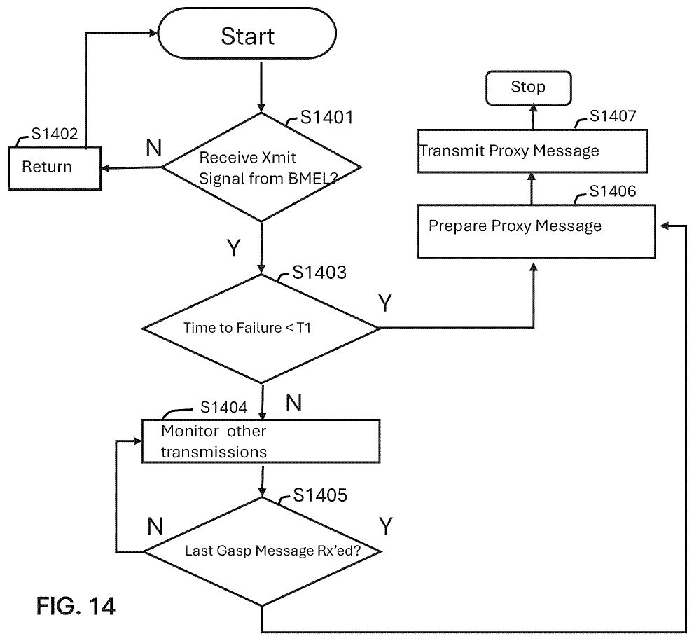

FIG. 14 is an algorithm performed by processing hardware of a second BMEL that is within communication range of a failed, or failing, BMEL. The second BMEL serves as a relay on behalf of the failed or failing BMEL and continues to transmit a last gasp proxy message on behalf of the failed or failing BMEL The process initially performs a query in step S1401 regarding whether a signal is received from a BMEL. If the response is negative, the process returns to the start via step S1402 and resumes after some delay. However, if the response to the query in step S1401 is affirmative, the process proceeds to another query in step S1403 where a determination is made whether the other BMEL has a time to failure of less than a threshold T1. If the response is affirmative, the process proceeds to step S1406 where a last gasp message is prepared and then transmitted in step S1407. However, if the response to the query in step S1403 is negative, the process proceeds to step S1404 where additional transmission are monitored, and then in step S1405 another query made regarding whether one of those transmission received from the other BMEL is a last gasp transmission. If the response is negative the process returns to step S1404. However, if the response is affirmative, the process proceeds to step S1406, and then followed by step S1407.

FIG. 15 is a diagram illustrating an example of training and using a machine learning model in connection with, for example, controlling the illumination of a legal path of egress in various conditions such as a blocked path, a presence of an active shooter, or an environmental situation such as smoke or fire detected in part of a building. The machine learning model training and usage described herein may be performed using a machine learning system. The machine learning system may include, or may be included in, circuitry that is configured by execution of software instructions to perform the disclosed operations and/or previously configured to perform the disclosed operations (e.g., ASIC(s): Application Specific Integrated Circuit(s) and/or PAL(s): Programmable Array Logic(s)). Moreover, the circuitry may be embodied in various forms such as one or more of a processor, a controller, an ASIC or PAL, a computer, a server, and/or a cloud computing environment, among other examples, such as the BMEL or a network of BMELs described in more detail elsewhere herein. The circuitry may be integrated with a sensor in a composite structure such that the circuitry performs operations on data provided by the sensor, or the circuitry is physically separated from the sensor. Moreover, the circuitry may be distributed as multiple circuits that exchange data via a wired bus, or wirelessly.

A portion of the training data set includes a set of observations 1505. The set of observations 1505 are included as portions of data structures that are also populated with training data, such as feature set 1510, and target variables 1515, as will be discussed. Data in the data structures may be labelled or unlabeled. The set of observations 1505 may be obtained from training data (e.g., historical data), such as data gathered during one or more processes described herein. In some implementations, the machine learning system may receive the set of observations 1505 (e.g., as input) from image, temperature, or other sensors hosted on the BMEL and/or information provided by another asset of a network of BMELs that communicate with one another, as described elsewhere herein.

Associated with the set of observations 1505 may include a feature set 1510. The feature set 1510 may include a set of variables, where each variable may be referred to as a feature. A specific observation may include a set of variable values (or feature values) corresponding to the set of variables. In some implementations, the machine learning system may determine variables for a particular set of observations and/or variable values for a specific observation based on input received from the sensor(s) or communication device of the BMEL For example, the machine learning system may identify a feature set 1510 (e.g., one or more features and/or feature values) by extracting the feature set from structured data, by performing natural language processing to extract the feature set from unstructured data, and/or by receiving input from an operator.

As an example, a particular feature set for particular a set of observations may include a first feature of a pathwidth of an aisleway in store, a second feature of a position of an object (or detected event such as a fire or an active shooter) in an aisleway (an aisleway near the BMEL or the network of aisleways serviced by a network of BMELs distributed over the aisleways, and exits, in a store or other building), a third feature such as optical clarity in locations in the aisleways (perhaps obscured by smoke or objects), a fourth feature such as the operational status of other BMELs disposed over candidate paths of egress, and so on. As shown, for a first observation, the first feature may have a value of 0 to 20 regarding feet of unobscured width of an aisleway covered by a subject BMEL, the second feature may have a value of 0 to 5, in increments of one, as an indication of a degree of obstruction and the nature of the obstruction (e.g., a fallen object that blocks just a few inches of the aisleway may have a low value such as 1, while a fire that only occupies a small part of the aisleway is extremely severe and so the value would be 4 or 5), the third feature may have a value of 1 to 5 (1 being lit and clear and 5 being unlit and opaque), the fourth feature being 1 to N, where N is the number of BMELs in the system and the associated BMEL location on a map of the candidate paths of egress in the building, and so on. These features and feature values are provided as examples and may differ in other examples.

The set of observations 1505 may each be associated with a target variable 1515. The target variable 1515 may represent a variable having a numeric value (as discussed above), may represent a variable having a numeric value that falls within a range of values or has some discrete possible values, may represent a variable that is selectable from one of multiple options (e.g., one of multiples classes, classifications, and/or labels, among other examples) and/or may represent a variable having a Boolean value. A target variable may be associated with a target variable value, and a target variable value may be specific to an observation. In the illustrated example, the target variable is degree of unobstructed aisleway, which has a value of 1-20 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model. As an example, the machine learning model (AI engine) may be trained from a series of images which have labeled features, including, for examples, features 1-4 discussed above.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

The machine learning system may train a machine learning model (AI engine) using the set of observations 1505 and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 1525 to be used to analyze new observations. The trained machine learning model 1525 may be embodies as a trained CNN (Convolutional Neural Network) or multiple CNNs, which is an example of an AI (Artificial Intelligence) engine.

As an example, the machine learning system may obtain training data for the set of observations based on labeled images of aisleways taken from the vantage point of various BMELs in a wide variety of conditions.

The machine learning system may apply the trained machine learning model 1525 to a new observation 1530, such as by receiving the new observation 1530 and inputting the new observation 1530 to the trained machine learning model 1525. As shown, the new observation 130 may include a first feature of degree of obstruction of an aisleway, a second feature of position of an object, a third feature of optical clarity in an aisleway, and so on, as an example. The machine learning system may apply the trained machine learning model 1525 to the new observation 1530 to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 1525 may predict a value of fatally obstructed, or not, for the target variable 1535 of the degree of obstruction in an aisleway for the new observation 1530. Based on this prediction, the machine learning system may provide a first recommended path of egress that includes/excludes the aisleway under the subject BMEL, as an output for determination of a first recommendation (e.g., for use by a central controller that provides a total path of egress, and associated control signals that provide an illuminated legal path of egress for all spaces in the building), may perform a first automated action (e.g., control a particular BMEL to illuminate the aisleway or not), and/or may cause a first automated action to be performed (e.g., by instructing another BMEL to perform the automated action, e.g., report the status of a failed BMEL that is near the BMEL that reports the status of the failed BMEL on behalf of the failed BMEL), among other examples. The first recommendation may include, for example, using the aisleway under the BMEL, for example. The first automated action may include, for example, reporting the status of the failed BMEL which is near the subject BMEL.

In some implementations, the trained machine learning model 1525 may classify (e.g., cluster) the new observation in a cluster 1540. The observations within a cluster may have a threshold degree of similarity. For example, if the historical records indicate that the aisleway under one BMEL is obstructed and not a viable component of a legal path of egress, then an adjacent BMEL in the same aisleway sector (e.g., a portion of an aisleway path of the map of networked BMELs/aisleways in the building that is bounded on both ends by intersecting aisleways). As an example, if the machine learning system classifies the new observation in a first cluster (e.g., viable/not-viable pathway), then the machine learning system may provide a first recommendation, such as the first recommendation described above to include/avoid the aisleway segment as part of the path of egress that will be illuminated during the event that triggers the need for the illumination of the path of egress.

As another example, if the machine learning system were to classify the new observation 1530 in a second cluster (e.g., detected a degree of obscured clarity by an adjacent BMEL), then the machine learning system may provide a second (e.g., different) recommendation (e.g., a weight applied to the aisleway that still allows that aisleway to be used if no better alternatives are identified).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 1525 may be re-trained using feedback information. For example, feedback may be provided to the machine learning model. The feedback may be associated with actions performed based on the recommendations provided by the trained machine learning model 1525 and/or automated actions performed, or caused, by the trained machine learning model 1525. In other words, the recommendations and/or actions output by the trained machine learning model 1525 may be used as inputs to re-train the machine learning model (e.g., a feedback loop may be used to train and/or update the machine learning model). For example, the feedback information may include manually selected paths of egress in a particular event that is an override to output from the model.

In this way, the machine learning system may apply a rigorous and automated process to identify a path of egress, as described in more detail elsewhere herein. The machine learning system may enable recognition and/or identification of tens, hundreds, thousands, or millions of features and/or feature values for tens, hundreds, thousands, or millions of observations, thereby increasing accuracy and consistency and reducing delay associated with identifying a path of egress relative to requiring computing resources to be allocated for tens, hundreds, or thousands of operators to manually [provide an example] using the features or feature values.

As indicated above, FIG. 15 is provided as an example. Other examples may differ from what is described in connection with FIG. 15.

Numerous modifications and variations of the aspects of the disclosed subject matter are possible in light of the above disclosure. It is therefore to be understood that within the scope of the appended claims, the disclosure may be practiced otherwise than as specifically described herein.

1. A lighting apparatus comprising:
a power interface configured to receive house-power from a remote power source via electrical conductors dedicated to powering building egress devices, and receive electrical power from a back-up power source provided as part of a lighting network;
an egress light source that is connected to the power interface and produces light to illuminate at least a portion of a path of egress in a building;
electrical power generation circuitry configured to generate power via at least one of induction, photonic power conversion, or via direct electrical connectivity from a local generation source, power from the electrical power generation circuitry being different than power from disposable batteries, the house-power, or the back-up power source;
power storage circuitry that stores power provided from the electrical power generation circuitry; and
circuitry configured to operate on the house-power during a standard mode of operation, operate on power from the back-up power source during an emergency backup mode of operation, and operate on the power stored in the power storage circuitry under degraded mode of operation in which the house-power and the back-up power are unavailable, wherein
while in the degraded mode of operation, the circuitry is further configured to
execute built-in-tests of components of the lighting apparatus,
generate a status message including information regarding status of the components of the lighting apparatus, the information further including at least one of an assigned address of the lighting apparatus, a position of the lighting apparatus with regard to an electronic building plan that is configured to display an indication of the lighting apparatus having the degraded mode of operation, and
transmit the status message to a remote client that is communicatively coupled to the electronic building plan so the lighting apparatus is displayed on the electronic building plan with an indication the lighting apparatus is operating in the degraded mode of operation.

2. The lighting apparatus of claim 1, further comprising a sensor, the sensor being at least one of an optical sensor, a temperature sensor, a light level sensor, and a voltage or current sensor.

3. The lighting apparatus of claim 1, wherein the status message includes information that identifies a failed subcomponent of the lighting apparatus, and the information that identifies the failed subcomponent includes a sub-address that is associated with the assigned address of the lighting apparatus.

4. The lighting apparatus of claim 3, wherein the circuitry is configured to generate and transmit the status message with a last measured operational parameter of the subcomponent.

5. The lighting apparatus of claim 1, wherein the status message includes an indication of at least one of a power connectivity fault, a power charging fault, and a fault of a device coupled to the lighting apparatus.

6. The lighting apparatus of claim 1, wherein the circuitry is configured to receive a transmission from the remote client.

7. The lighting apparatus of claim 6, wherein the circuitry is configured to control an operational condition of at least one subcomponent of the lighting apparatus based on the transmission received from the remote client.

8. The lighting apparatus of claim 1, wherein the processing circuitry shares data resources with circuitry of the remote client.

9. A lighting apparatus comprising:
a power interface;
an egress light source that is connected to the power interface and produces light to illuminate at least a portion of a path of egress in a building;
power storage circuitry that stores power provided from electrical power generation circuitry that produces electricity from power generated locally on the lighting apparatus, the power being generated locally on the lighting apparatus being different than power from disposable batteries, house-power, or back-up power provided externally to the lighting apparatus; and
circuitry configured to
execute built-in-tests of components of the lighting apparatus,
generate a status message including information regarding status of the components of the lighting apparatus, and
in a degraded mode of operation in which power is provided via the power storage circuitry, without house-power, disposable batteries, or back-up power, continue to perform the built-in-tests and transmit the status message to a remote client.

10. The lighting apparatus of claim 9, wherein at least a portion of the power stored in the power storage device is generated by an onboard power generating device.

11. The lighting apparatus of claim 9, wherein the circuitry includes a transceiver that is configured to communicate with the remote client and with another transceiver coupled to a building system other than lighting.

12. The lighting apparatus of claim 9, wherein the circuitry is configured to implement a machine learning model trained to learn an ambient and operational environment within sensor range of an installation location of the lighting apparatus.

13. The lighting apparatus of claim 9, wherein the circuitry is configured to implement a machine learning model trained to prioritize real time alerts reported to a remote client based on a risk assessment.

14. The lighting apparatus of claim 9, wherein the circuitry is configured to communicate with at least another lighting apparatus to identify a path of egress that avoids a detected obstacle or hazard in an aisleway.

15. A lighting apparatus comprising:
a power interface;
an egress light source that is connected to the power interface and produces light to illuminate at least a portion of a path of egress in a building;
power storage circuitry that stores power provided from electrical power generation circuitry that produces electricity from power generated locally on the lighting apparatus, the power generated locally on the lighting apparatus being different than power from disposable batteries, house-power, or back-up power provided externally to the lighting apparatus; and
circuitry configured to
execute built-in-tests of components of the lighting apparatus,
execute a machine learning model trained to identify a hazard in a candidate path of egress,
provide a status message to a remote client that aggregates status information from a network of lighting apparatuses, and identifies a path of egress that avoids the hazard and avoids an aisleway under the lighting apparatus under a condition the lighting apparatus informs the remote client that the lighting apparatus has insufficient power to adequately illuminate a floor below an installation position of the lighting apparatus.

16. The lighting apparatus of claim 15, wherein the status message includes more information regarding an operation status of the lighting apparatus during a standard mode of operation, than under a degraded mode of operation in which the lighting apparatus operates only with power generated locally on the lighting apparatus.

17. The lighting apparatus of claim 16, wherein the status message includes a device ID and fault ID of a subcomponent of the lighting apparatus.

18. The lighting apparatus of claim 16, wherein the status message includes information of at least one of a time to failure and a last gasp flag.

19. The lighting apparatus of claim 15, wherein the circuitry is configured to receive a status message from another lighting apparatus, and generate and transmit a proxy message on behalf of the another lighting apparatus to the remote client that includes a failure status and at least one of an ID, an address, or location information of the another lighting apparatus.

20. The lighting apparatus of claim 19, wherein the proxy message is a last gasp proxy message for the another lighting apparatus.
